(19) United States
(12) Patent Application Publication
(10) Pub. No.: US 2016/0004664 A1
(43) Pub. Date: Jan. 7, 2016

(54) BINARY TENSOR FACTORIZATION

(71) Applicant: XEROX Corporation, Norwalk, CT (US)

(72) Inventors: Guillaume Bouchard, Saint-Martin-Le-Vinoux (FR); Beyza Ermis, Uskudar/Istanbul (TR)

(21) Appl. No.: 14/321,886

(22) Filed: Jul. 2, 2014

(51) Int. Cl. G06F 17/16

(52) U.S. Cl. CPC G06F 17/16

(57) ABSTRACT

In factorization of binary matrices or tensors, training algorithms usually scale linearly with the number of training examples. For very unbalanced learning problems, the number of non-zero training examples can be much smaller than the number of zeros in the full dataset. For some problems where the squared norm can be efficiently computed, the training time complexity can be reduced. A method herein receives a binary tensor defined by matrices comprising elements in a database. A processing device determines an upper bound for non-quadratic losses associated with factorization of the binary tensor. The upper bound is based on a variation parameter. The processing device performs factorization of the binary tensor by alternately minimizing the upper bound with respect to the variation parameter and minimizing the upper bound with respect to the elements of the matrices using a gradient descent method.

### BACKGROUND

Systems and methods herein generally relate to factorization methods and, more particularly, to methods to perform binary tensor factorization.

In supervised classification, many estimation problems involve unbalanced datasets, i.e. one of the available categories contains the vast majority of the training examples. This category often corresponds to the default category, and the training examples belonging to it are called negative data points, since they are counter-examples of positive data points, on which the classifier needs to focus. Training algorithms usually scale linearly with the number of training examples; however, for very unbalanced learning problems, the number of non-zero training examples can be much smaller than the number of zeros in the full dataset. Factorizing binary tensors is an essential problem to predict entries in knowledge bases, but the only scalable solution was approximate (minimization of a Euclidean norm). For some problems where the squared norm can be efficiently computed, the training time complexity can be reduced.

Nevertheless, the squared loss is not always satisfactory. For example, binary tensor decomposition with logistic loss gives much better predictive performances than minimizing the squared loss. The downside of it is that the computational cost increases significantly, and one usually relies on heuristic rules to subsample negative examples. The time to minimize the logistic loss (or other non-quadratic loss) scales linearly in the total number of observations, which is a real issue in heavily unbalanced datasets for which the number of positive data points is much, much less than the number of negative data points.

### SUMMARY

Disclosed herein is a new way of factorizing a binary tensor that smoothly interpolates between a fast and inaccurate solution and a precise but slow solution. The methods herein are based on the minimization of a piece-wise quadratic upper bound to the exact (but costly to compute) objective.

According to a method herein, a processing device receives a tensor defined by matrices comprising elements in a database. The processing device performs factorization of the tensor. The factorization comprises identifying disjoint blocks of elements in the tensor. Ones of the disjoint blocks having maximal variance in the absolute values of a predicted value of the elements in the blocks are split. An upper bound is determined on every one of the disjoint blocks of the tensor for losses associated with the factorization. The upper bound is minimized with respect to a variation parameter and elements in the factorization using a gradient descent function.

According to another method herein, a processing device receives a binary tensor defined by matrices comprising elements in a database. The processing device determines an upper bound for non-quadratic losses associated with factorization of the binary tensor. The upper bound is based on a variation parameter. The processing device performs factorization of the binary tensor by minimizing the upper bound with respect to the variation parameter and the elements of the matrices using a gradient descent function.

According to a computer program product for conducting factorization of tensors, the computer program product comprises a computer readable storage medium having program instructions embodied therewith. The program code is readable and executable by a processor to cause the processor to perform a method. According to the method, a tensor defined by matrices comprising elements in a database is received. The elements in the database are classified by identifying blocks of elements in the matrices. Ones of the blocks having maximal variance in the absolute values of a predicted value of the elements in the blocks are split. Factorization of the tensor is performed according to the blocks of elements. The factorization comprises determining an upper bound for losses associated with the factorization by minimizing the upper bound with respect to a variation parameter and the elements in the matrices using a gradient descent function.

According to a computer system for conducting binary tensor factorization, a knowledge database is defined as a binary tensor. A processing device is connected to the knowledge database. A program product comprises a computer readable storage medium having program code embodied therewith. The program code is readable and executable by the processing device to perform a method. According to the method, the binary tensors are factorized. The factorizing comprises interpolating between a fast, imprecise solution to the factorizing and a slow, precise solution to the factorizing, based on minimizing a quadratic upper bound to the precise solution using piece-wise blocks of elements in the binary tensor.

These and other features are described in, or are apparent from, the following detailed description.

### BRIEF DESCRIPTION OF THE DRAWINGS

Various examples of the systems and methods are described in detail below, with reference to the attached drawing figures, which are not necessarily drawn to scale and in which:

FIG. 1 is a block diagram of a system according to systems and methods herein;

FIG. 2 is a graph comparing Gaussian and logistic functions according to systems and methods herein;

FIG. 3 shows an example of matrix splitting according to systems and methods herein;

FIGS. 4A and 4B show exemplary portions of software code according to systems and methods herein;

FIG. 5 shows graphs illustrating the bound refinement process according to systems and methods herein;

FIGS. 6A and 6B show comparison graphs according to systems and methods herein;

FIG. 7 is a flow diagram according to systems and methods herein;

FIG. 8 is a schematic diagram illustrating devices herein; and

FIG. 9 is a schematic diagram illustrating systems herein.

### DETAILED DESCRIPTION

While the disclosure will now be described in connection with specific devices and methods thereof, it will be understood that limiting the disclosure to such specific devices and methods is not intended. On the contrary, it is intended to cover all alternatives, modifications, and equivalents as may be included within the spirit and scope of the disclosure as defined by the appended claims.

For a general understanding of the features of the disclosure, reference is made to the drawings. In the drawings, like reference numerals have been used throughout to identify identical elements.

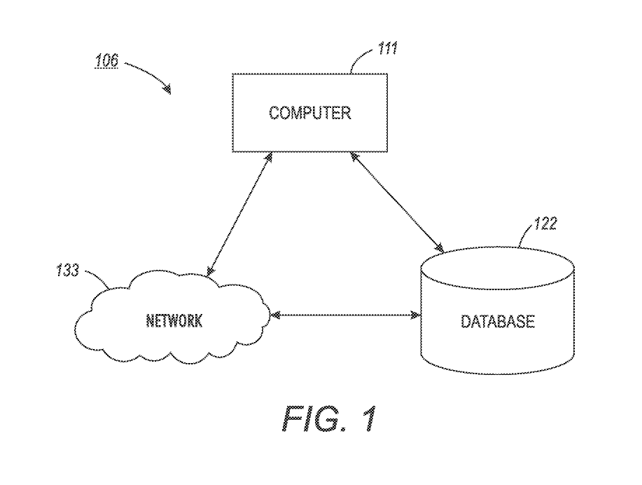

FIG. 1 is a general overview block diagram of a system, indicated generally as 106, for communication between a computer 111 and a database 122. The computer 111 may comprise any form of processor as described in further detail below. The computer 111 can be programmed with appropriate application software to implement the methods described herein.

Database 122 includes any database or any set of records or data that the computer 111 desires to retrieve. Database 122 may be any organized collection of data operating with any type of database management system. The database 122 may contain matrices of datasets comprising multi-relational data elements.

The database 122 may communicate with the computer 111 directly. Alternatively, the database 122 may communicate with the computer 111 over network 133. The network 133 comprises a communication network either internal or external, for affecting communication between the computer 111 and the database 122. For example, network 133 may comprise a local area network (LAN) or a global computer network, such as the Internet.

A tensor may be used to represent data and various relationships among the elements of data. From an application point of view, tensor factorization can be used to discover latent features underlying the interactions between different kinds of entities.

For example, in a recommendation system, there may be a group of users and a set of items. Given that each of the users have rated some items, but not all items, in the system, a problem may be to predict how the users would rate the items that they have not yet rated, such that recommendations can be made to other users. For this example, all the information about the existing ratings can be represented in a matrix. Table 1 shows 5 users and 4 items. The ratings from each user are binary integers equal to either one (if they like the item) or zero (if they do not like the item. A hyphen means that the user has not yet rated the item:

TABLE 1

| | D1 | D2 | D3 | D4 |
|---|---|---|---|---|
| U1 | 1 | 0 | - | 0 |
| U2 | 1 | - | - | 0 |
| U3 | - | 0 | - | 1 |
| U4 | 0 | - | - | 1 |
| U5 | - | 0 | 1 | 1 |

The task of predicting the missing ratings can be considered as filling in the blanks such that the values would be consistent with the existing ratings in the matrix.

According to systems and methods herein, let [symbol] be a discrete output space. For binary prediction [symbol] ={0; 1}, and for count data modeling, [symbol] ={0, 1, 2, . . . }. Let's consider a large but finite space of all possible observation indices. We are given a dataset y={yₜ, tεΩ+∪Ω−} of observations, where Ω+ are indices of non-zero observations, i.e. yₜ≠0, ∀tεΩ+, and Ω− contains all the indices of observed zeros, i.e. yₜ=0, ∀tεΩ−. We also identify the missing elements, that is to say the indices that did not lead to an observation, at Ω^{m}, so that we have the relation Ω=Ω+∪Ω−∪Ω^{m}, with the mutually disjoint sets Ω+, Ω−, and Ω^{m}.

It is assumed that the dataset is strongly unbalanced, i.e. |Ω|>>|Ω+|∪|Ω^{m}|. This means that there are much more negative examples for which yₜ=0 than positive examples for which yₜ≠0. In most of the existing learning methods, the prediction loss [symbol] is decomposable, i.e. it is the sum of loss over each observation: [symbol] (Z, Y):=Σ_{tεΩ+∪Ω-}|(zₜ, yₜ), where zₜ are the predictions of the method. A simple calculus is made to decompose this loss into three parts:

$$\begin{matrix}ℒ ( Z , Y ) = {\sum }_{t ∈ Ω + ⋃ Ω -} l ( {z}_{t} , {y}_{t} ) \\ = {\sum }_{t ∈ Ω +} l ( {z}_{t} , {y}_{t} ) + {\sum }_{t ∈ Ω -} l ( {z}_{t} , 0 ) \\ = {\sum }_{t ∈ Ω +} l ( {z}_{t} , {y}_{t} ) + {\sum }_{t ∈ Ω - \{ Ω + ⋃ {Ω}^{m} \}} l ( {z}_{t} , 0 ) \\ = {\sum }_{t ∈ Ω +} l ( {z}_{t} , {y}_{t} ) + {\sum }_{t ∈ Ω} l ( {z}_{t} , 0 ) - \\ {\sum }_{t ∈ Ω +} l ( {z}_{t} , 0 ) - {\sum }_{t ∈ Ω} l ( {z}_{t} , 0 ) \\ = {ℒ}^{\pm } ( Z , Y ) + {ℒ}^{Ω} ( Z ) - {ℒ}^{m} ( Z ) ,\end{matrix} \qquad ( 1 )$$

where [symbol] ^{±}=Σ_{tεΩ+}(|(zₜ, yₜ)−|(zₜ, 0)) is the loss difference between positive and negative observations computed only on positive data points, [symbol] ^{Ω}:=Σ_{tεΩ}|(zₜ, 0) is the loss obtained if all the data where considered as negative examples and [symbol] ^{m}:=Σ_{tεm}|(zₜ, 0) is the additional loss that would be added if all the missing data were considered as negative instead of missing. The cost of computation [symbol] ^{±} and [symbol] e^{Ω} is linear in the number of positive and missing examples, respectively. However, [symbol] ^{Ω} contains as many terms in its summand as there are elements in the full observation space.

If we consider the squared loss |(z, y)=½(z−y)², we obtain:

$$\begin{matrix}ℒ ( Z , Y ) = {ℒ}^{\pm } ( Z , Y ) + {ℒ}^{Ω} ( Z ) - {ℒ}^{m} ( Z ) \\ = \frac{1}{2} {\sum }_{t ∈ Ω +} ( {( {z}_{t} - {y}_{t} )}^{2} - {z}_{t}^{2} ) + \\ \frac{1}{2} {\sum }_{t ∈ Ω} {z}_{t}^{2} - \frac{1}{2} {\sum }_{t ∈ {Ω}^{m}} {z}_{t}^{2} \\ = - {\sum }_{t ∈ Ω +} {z}_{t} {y}_{t} + {\sum }_{t ∈ Ω} {z}_{t}^{2} - {\sum }_{t ∈ {Ω}^{m}} {z}_{t}^{2} + C\end{matrix} \qquad ( 2 )$$

where C:=Σ_{tεΩ+}yₜ² is a constant that does not depend on the predictions.

In Equation (2), the summand Σ_{tεΩ}zₜ²:=∥Z∥_{F}² corresponds to the computation of the Frobenius norm of all the possible predictions in the dataset. For the problems mentioned in the introduction, i.e. tensor factorization and object detection methods in computer vision, this norm can be computed efficiently using the structure of the problem. In the object detection example, the circulant structure of the design matrix can be used to efficiently compute ∥Z∥ using fast Fourier transforms. In the following, we will focus only on the other application, i.e. factorization models.

Factorization Models

Consider learning a matrix (D=2) or a tensor YεYⁿ₁^{× . . . ×n}_{D} of order D>2 for which the dimensions n₁, n₂, . . . , n_{D} are known. We have Ω={tε·^{D}; t_{d}≦n_{d}, ∀dε{1, . . . , D}}. As used herein, capital letters represent tensors, such as YεYⁿ₁^{× . . . ×n}_{D}, and corresponding lower-case characters identify elements of the tensor (e.g. yₜ) indexed by D-uplets, such as t=(i₁, . . . , iₙ), where i_{d}ε{1, . . . , n_{d}}, ∀dε{1, . . . , D}.

Matrix factorization Recent fast learning methods based on implicit feedback are based on the fact that predictions z_{(i;j)} are K-dimensional dot products [symbol] θᵢ⁽¹⁾,θⱼ⁽²⁾ [symbol] , K being the rank of the factorization model, and θᵢ^{(d)} representing the i-th row of the n_{d}×K factor matrix Θ_{d}, dε{1, 2}. The complexity of computing [symbol] ^{Ω} can be reduced from O(n₁n₂K) if the dot product for each entry of the full n₁×n₂ matrix to O((n₁+n₂)K²) is computed by using the property of the trace operator:

$$\begin{matrix}{\sum }_{t ∈ Ω} {z}_{t}^{2} = {\sum }_{i = 1}^{{n}_{1}} {\sum }_{j = 1}^{{n}_{2}} {z}_{( i , j )}^{2} = tr ( {ZZ}^{T} ) \\ = tr ( {θ}_{1} {θ}_{2}^{T} {θ}_{2} {θ}_{1}^{T} ) \\ = tr ( {θ}_{1}^{T} {θ}_{1} {θ}_{2}^{T} {θ}_{2} ) \\ = tr ( {M}^{( 1 )} {M}^{( 2 )} ) ,\end{matrix} \qquad ( 3 )$$

where Z={z_{(i,j)}}_{i,j}, and M⁽¹⁾ and M⁽²⁾ are K×K matrices. Each of these matrices can be obtained in a time n_{d}K² for dε{1, 2}.

This calculus provides an alternative derivation of the alternating least square method. This also illustrates that alternating optimization is not the only method that can scale linearly with the number of positive observations. Other methods may include a gradient descent process, stochastic gradient descent, coordinate descent, or svd-based learning methods.

Multilinear Prediction

Multilinear prediction methods are generalizing matrix factorization in multiple ways, but the main ones are tensor factorization and collective matrix factorization. As described herein, only multi-linear models based on the PARAFAC tensor parameterization are considered. The predicted tensor Z(θ) is assumed to be parameterized by a set θ=(Θ₁, . . . , Θ_{D}) of matrices representing K-dimensional latent factors. Hence, the total number of parameters is p=K×Σ_{d}n_{d}. The predictions zₜ are obtained by the multilinear product of factors represented in the rows of matrices Θ_{d}, dε{1, . . . , D}:

$${z}_{t} = {\sum }_{k = 1}^{K} {\prod }_{d = 1}^{D} {θ}_{{t}_{d} k}^{( d )} := 〈 {θ}_{{t}_{1}}^{( 1 )} , … , {θ}_{{t}_{D}}^{( D )} 〉 .$$

Equivalently, the full prediction tensor can be written as Z(θ)=[Θ₁, . . . , Θ_{D}]. A naive computation of the Euclidean norm of Z(θ) would require O(KΠ_{d}n_{d}) operations, since there are Π_{d}n_{d} possible predictions. Equation (3) is generalized to the multilinear case, leading to the formula:

$${\sum }_{t ∈ Ω} {z}_{t}^{2} = {\sum }_{k = 1}^{K} {\sum }_{{k}^{′} = 1}^{K} {\prod }_{d = 1}^{D} {M}_{{kk}^{′}}^{( d )} . \qquad ( 4 )$$

For tensors of high order D, a near exponential speedup may be achieved as Equation (4) can be computed in O(K² E_{d}n_{d}) operations. It is interesting to see that there is no further dependency on the rank, since the K² term does not directly depend on the tensor order D.

In order to minimize the loss [symbol] (Z(θ)) with respect to θ using block-coordinate descent, the iterations end up being least squares problems with a per-iteration complexity that scales linearly with the number of positive examples only. This corresponds exactly to the iTALS method, which is a tensor generalization of the alternating least square method. In experiments described below, a gradient descent was used to minimize the objective function. For moderate values of the rank K, the negative loss [symbol] ⁻(Z(θ)) is faster to compute than [symbol] ^{±}(Z(θ), Y), so every gradient computation has a complexity linear in the number of non-zero elements in the tensor.

One problem, however, is that the squared loss is not always appropriate for learning binary predictors. It is well known that least-square learning is significantly outperformed by logistic regression or hinge loss minimization (a.k.a. Support Vector Machines). Linear regression is rarely used to train a classifier, with the notable exception of some recommendation systems. There are some historical reasons to use linear regression, nonetheless. For example, the objective criterion of the Netflix prize was the Root Mean Squared Error (RMSE).

Additionally, there is a rational explanation of the use of squared loss in recommender systems. For example, in the user recommendation business, the predicted variable is the preference of the user or the buying decision of a potential customer. This problem is noisy by nature since its goal is to predict the user decision. There are many contextual factors that cannot be measured, and it is clear that human decisions, especially related to tastes and preferences, are nearly impossible to predict deterministically. One rule of thumb is that if the prediction probabilities are always in the range 10%-90%, then using RMSE or logistic loss minimization gives similar prediction performances.

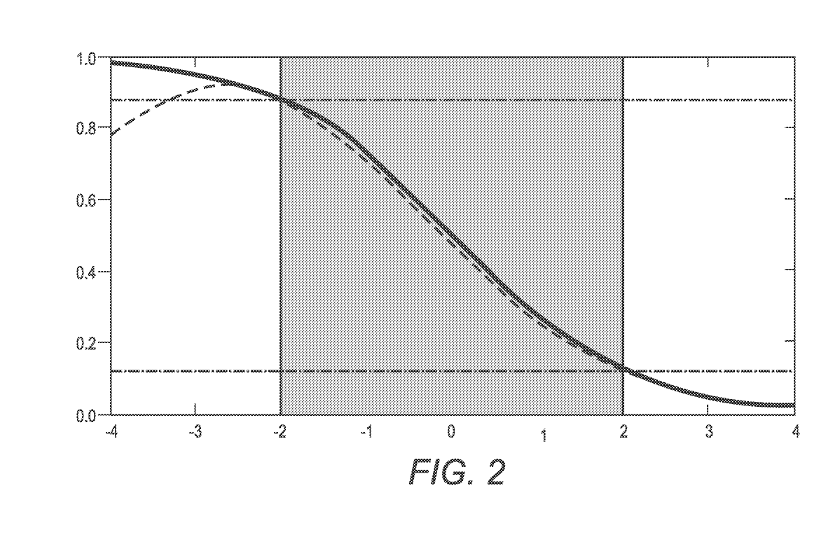

FIG. 2 illustrates a comparison of the logistic function and the Gaussian distribution. The Gaussian distribution approximates well the logistic function in a range of values (gray area in the range [−2, 2]) that corresponds to probabilities between 0.12 and 0.88 (dotted lines). In most recommender systems applications, the probability of correctly predicting user choice is in this range, which explains that RMSE loss is reasonable.

Nevertheless, in many other applications, and in particular in the relational data prediction, some relations are nearly deterministic. For example, if the relation to predict is a family relation (e.g. isFatherOf), an observable attribute (e.g. hasCountry), or an ownership relation (e.g. belongsTo, containsObject), a model can be expected to give prediction probabilities in the order of 99% or 99.9% (or inversely 1% or 0.1%, when there is some evidence that the relation is not true). According to systems and methods herein, a process automatically balances the considerable speedup of the quadratic loss minimization with the ability to deal with non-quadratic loss for a better predictive accuracy.

For many losses, and in particular the logistic loss and the hinge loss used to model binary data, there exists a family of local quadratic upper bounds to the loss. According to systems and methods herein, a quadratic upper bound is minimized to the non-quadratic loss. Assume the following three components can be found:
a real-valued function λ: [symbol] [symbol] [symbol] ,
tensor-valued function M: [symbol] [symbol] [symbol] ⁿ₁^{× . . . ×n}_{D},
a real-valued function c: [symbol] [symbol] [symbol]
   such that for any value of ξ (called the variation parameter), the function [symbol] ^{Ω}Rⁿ₁^{× . . . ×n}_{D}× [symbol] [symbol] [symbol] defined by:

$${\overline{ℒ}}^{Ω} ( Z , ξ ) := \frac{τ ( ξ )}{2} {‖ Z - M ( ξ ) ‖}_{F}^{2} + c ( ξ ) , \qquad ( 5 )$$

is an upper bound to the original non-Gaussian negative loss [symbol] (Z). This implies an upper bound to the original loss [symbol] using Equation (1):

[symbol]

(Z(θ)≦ [symbol] ^{Ω}(Z(θ),ξ)+ [symbol] ^{±}(Z(θ),Y)− [symbol] ^{m}(Z(θ)). (6)

As usual with bound optimization, the method alternates between two steps:
1) minimizing the bound with respect to the variation parameter ξ using closed form updates or dichotomic search where no closed form solution exists; and
2) minimizing the bound with respect to θ using a standard gradient descent process.

This methodology is sometimes referred as Majorization-Minimization. Neglecting the missing values, and denoting by p the number of positive examples, the process minimizes the right-hand-side of Equation (6) with a complexity of O(min(Kp; K²Σ_{d}n_{d})) because [symbol] ^{Ω}(Z, ξ) is a quadratic function and can be computed in time O(K²Σ_{d}n_{d}), while [symbol] ^{±}(Z, Y) can be obtained in O(Kp) operations. In the experiments described herein, this process is called Quad-App.

Binary Observations

The logistic loss is bounded by:

log(1+e^{z})≦λ(z²−ξ²)±½(z−ξ)+log(1+e^{ξ})

where

$$λ ( ξ ) := \frac{1}{2 ξ} ( \frac{1}{1 + {e}^{ξ}} - \frac{1}{2} ) .$$

The same value for ξ is used for all the elements of the tensor Z, so that the upper bound has exactly the form required in Equation (5):

$${\overline{ℒ}}^{Ω} ( Z , ξ ) = λ ( ξ ) {‖ Z - \frac{1}{4 λ ( ξ )} {1}_{{n}_{1} \times … \times {n}_{D}} ‖}_{F}^{2} + c ( ξ )$$

The optimization of this bound with respect to ξ gives exactly the Frobenius norm of the tensor:

$${arg min}_{ξ} {\overline{ℒ}}^{Ω} ( Z , ξ ) = {‖ Z ‖}_{F} . \qquad ( 7 )$$

Poisson Observations

The negative log-likelihood for an observation y is λ(z)−y log(λ(z))+log Γ(y+1), where yε{1, . . . , n} is the observed count variable, z is the predicted latent variable, and λ(z):=log(1+e^{z}), to obtain a quadratic upper bound. This leads to the following bound:

$$log ( 1 + {e}^{z} ) - y log ( log ( 1 + {e}^{z} ) ) \leq λ ( ξ ) ( {z}^{2} - {ξ}^{2} ) + \frac{1}{2} ( z - ξ ) + log ( 1 + {e}^{ξ} ) - y ( log ( log ( 1 + {e}^{ξ} ) ) + \frac{( z - ξ ) σ ( ξ )}{log ( 1 + {e}^{ξ} )} ) .$$

Optimization with respect to ξ also gives Equation (7).

A drawback of this approach, even with one or two orders of magnitude speedups, is the resulting quadratic approximation can be quite loose for some data, and the accuracy of the method can be too low. According to devices and methods herein, a family of approximations interpolates between the fast but inaccurate quadratic approximation and the slow but exact minimization of the non-quadratic loss.

A bound is applied on a partition of the original tensor, i.e. a set [symbol] ={B₁, . . . , B_{|}_{_{B}}_{|}} of disjoint blocks is selected to partition the space of possible observation indices a Ω. On each of these blocks, the bounding technique is applied; however, the minimization with respect to θ is done jointly on all the blocks. That is, each block of elements B_{b}, bε{1, . . . , | [symbol] |} is identified by D sets of indices, which represent the dimensions that are selected in the given block b.

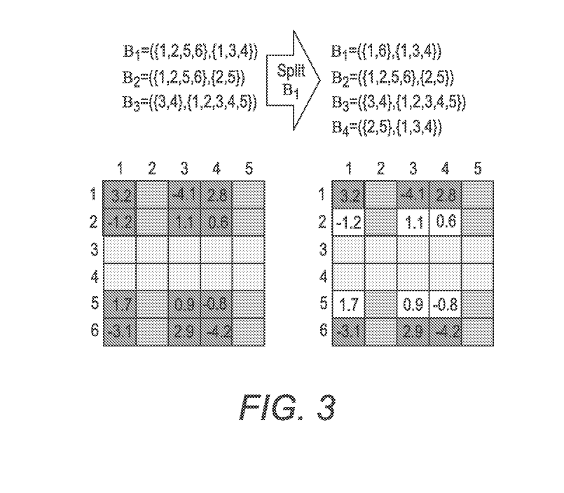

The indices are illustrated in a matrix example in FIG. 3, which shows an example of a matrix being split to improve upper bound accuracy. The colors identify the blocks. The numbers in the matrix represent predictions. The first block of elements [symbol] ₁ is decomposed into blocks 1 and 4, both having a small variance on the absolute value of the predictions.

To select the blocks, a greedy construction of the blocks is used: starting with a single block containing all the indices, i.e. [symbol] ={Ω}, the blocks are iteratively refined using the following two-step procedure, called RefineBlocks:
1. select the block b to split that has the maximal variance in the absolute values of the predictions |zₜ|;
2. split the block b into two blocks so that the variance of the absolute values of the predictions |zₜ| is minimized.

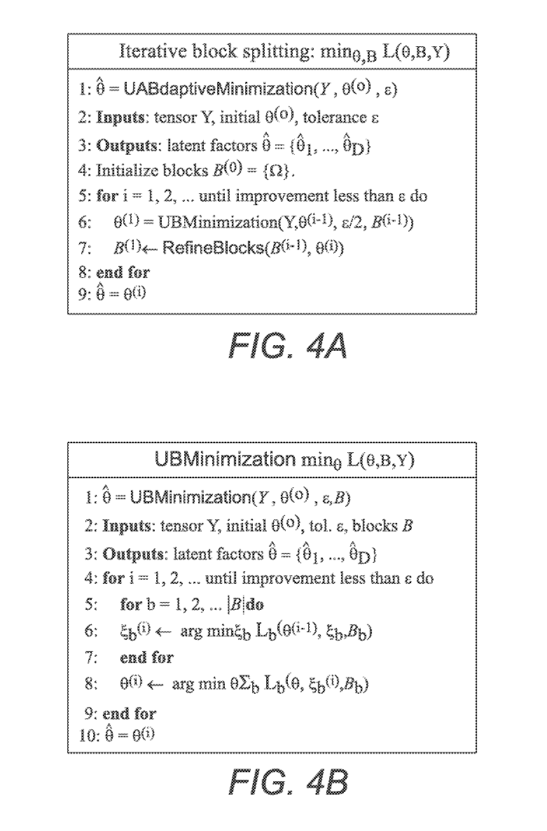

An example of software code that can be used to conduct such iterative block splitting is shown in FIG. 4A. The exemplary software code shown in FIG. 4A uses the exemplary software code for minimization shown in FIG. 4B as a sub-program to learn the parameters for a fixed set of blocks. There is a tradeoff between optimizing the bound using the minimization process shown in FIG. 4B and refining the partition using the iterative block splitting shown in FIG. 4A. A simple strategy that worked well in practice was to refine the partition when the upper bound minimization did not improve more than a given tolerance level c/2 in two successive iterations. This piecewise refinement strategy is called PW Quad-App.

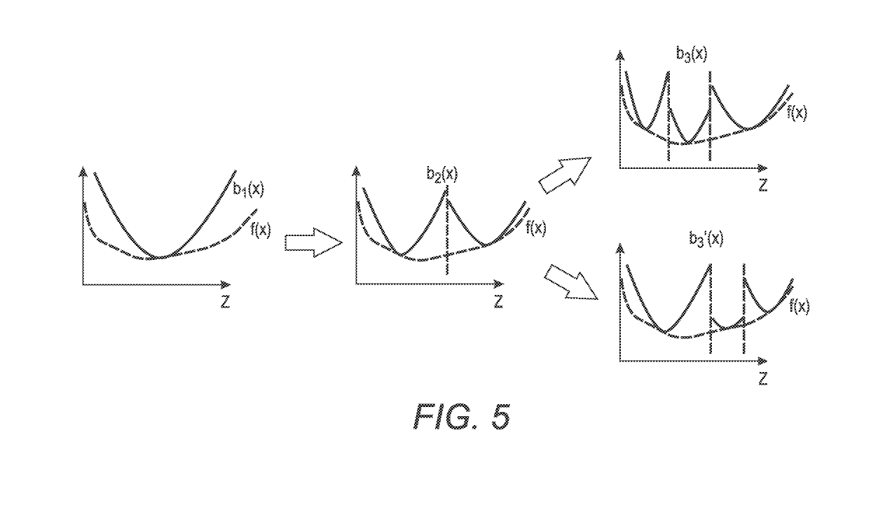

FIG. 5 graphically illustrates the bound refinement process by interpolating between a fast, imprecise solution to the factorizing and a slow, precise solution to the factorizing.

According to devices and methods herein, a variant of the process described above computes the exact logistic loss for pieces that have a small number of elements. For example, a threshold can be set at 1% of the total number of elements of the tensor in order to compute exact logistic loss. As illustrated below, this variant is called PW Quad-App+Logistic.

Synthetic Data Experiments

In order to explore the speed accuracy tradeoff, different binary matrices Y were generated by randomly sampling noisy low-rank matrices X=UV+E where UεRⁿ₁^{×r} and VεR^{r×n}₂ are generated using independent standard normal variables and EεRⁿ₁^{×n}₂ is a normally distributed Gaussian noise with standard deviation σ. To create the binary matrix Yε{0, 1}ⁿ₁^{×n}₂, the values of X were rounded using a high percentile of X as a threshold to produce a heavy tendency towards the negative class. An estimate \hat{X} of the original matrix X is learned on the data matrix Y assumed to be fully observed and the Root Mean Square Error (RMSE) is computed on the recovery of X, i.e. RMSE=∥X−\hat{X}∥F. The running time of each of the methods is measured to understand their scalability to large datasets.

The timing (in seconds) and accuracy (in AUC measure) of a gradient descent algorithm applied on the simulation data with various dimensions, noise levels, and sparsity percentages are shown in Table 2. Each column corresponds to one of the methods to compute the objective function or its upper bound, as described above.

TABLE 2

| | | | Methods | | | | | | | | | |
|---|---|---|---|---|---|---|---|---|---|---|---|---|
| Noise | | | EUC-Full | | EUC-Fast | | Logistic | | Quad-App | | PW QuadApp | |
| Level | Dimension | Sparsity | RMSE | Time | RMSE | Time | RMSE | Time | RMSE | Time | RMSE | Time |
| Low | n₁ = 100 | 10% | 0.6970 | 60.45 | 0.6970 | 0.50 | 0.3561 | 103.13 | 0.6421 | 0.58 | 0.4377 | 6.16 |
| Noise | n₂ = 50 | 1% | 0.6792 | 55.57 | 0.6792 | 0.46 | 0.1095 | 90.65 | 0.4568 | 0.56 | 0.1918 | 3.19 |
| σ = 0.1 | n₁ = 1000 | 1% | 0.7251 | 5295.7 | 0.7251 | 63.10 | 0.1563 | 7216.2 | 0.7054 | 75.49 | 0.3790 | 421.11 |
| | n₂ = 500 | 0.1% | 0.7251 | 5248.3 | 0.7251 | 42.90 | 0.2126 | 6605.6 | 0.7067 | 62.90 | 0.5247 | 301.35 |
| | n₁ = 10000 | 0.1% | 0.4483 | 84950 | 0.4483 | 1289.2 | 0.0497 | 68199 | 0.2052 | 1353.8 | 0.0911 | 6683.9 |
| | n₂ = 5000 | 0.01% | 0.4217 | 86109 | 0.4217 | 803.2 | 0.0329 | 66482 | 0.1814 | 1049.3 | 0.0583 | 4271.4 |
| High | n₁ = 100 | 10% | 2.8989 | 59.06. | 2.8989 | 0.48 | 1.2789 | 94.49 | 1.8639 | 0.73 | 1.3212 | 10.18 |
| Noise | n₂ = 50 | 1% | 2.8821 | 44.96 | 2.8821 | 0.37 | 0.2377 | 59.21 | 0.4589 | 0.54 | 0.2622 | 7.14 |
| σ = 2.0 | n₁ = 1000 | 1% | 2.6705 | 7070.3 | 2.6705 | 110.87 | 0.3371 | 6592.0 | 0.4052 | 132.55 | 0.3659 | 943.67 |
| | n₂ = 500 | 0.1% | 2.5116 | 7276.2 | 2.5116 | 109.99 | 0.0563 | 6503.1 | 0.1304 | 120.83 | 0.1078 | 783.91 |
| | n₁ = 10000 | 0.1% | 1.9990 | 97084 | 1.9990 | 1486.1 | 0.2312 | 66124 | 0.2604 | 1523.0 | 0.2374 | 7352.8 |
| | n₂ = 5000 | 0.01% | 1.7416 | 83846 | 1.7416 | 1183.0 | 0.1332 | 65664 | 0.1661 | 1589.6 | 0.1414 | 6613.1 |

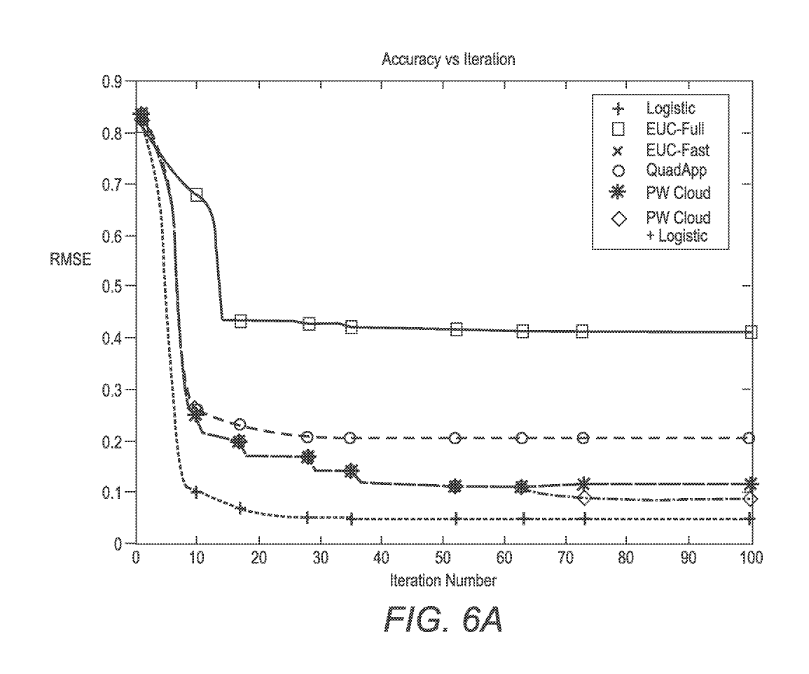

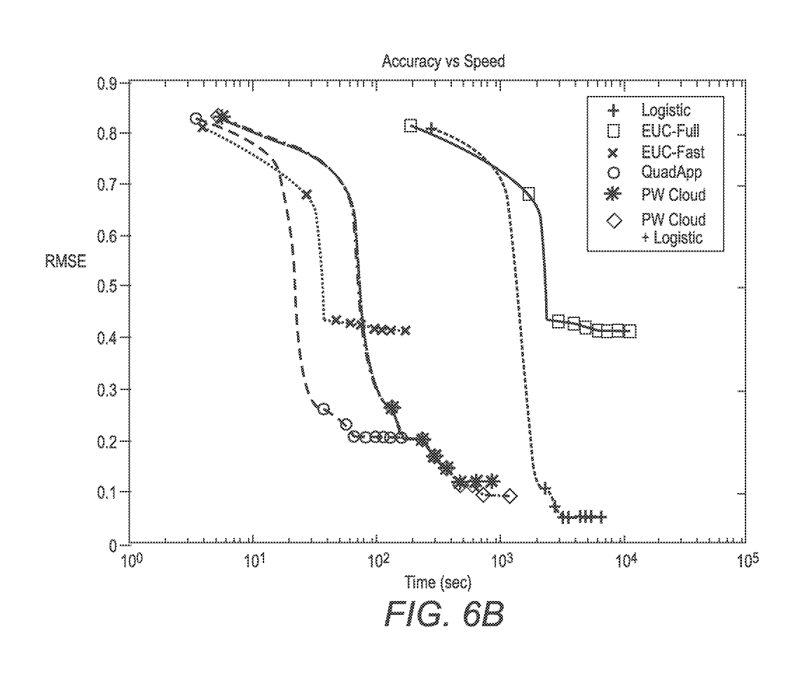

Table 2 illustrates the evaluation results for the synthetic experiments in terms of seconds for runtime and RMSE for matrix recovery. These results are averaged over 10 runs and we choose rank r=5 for every simulation. FIGS. 6A and 6B show the RMSE versus time for quadratic loss (EUC-Full and EUC-Fast), logistic loss, quadratic approximation, and piecewise methods. The logistic loss gives much smaller error rates than the quadratic loss and quadratic approximation, especially when the noise level is low. However, minimizing the logistic loss requires considerably more time than the alternative approaches as the problem size grows. These experiments highlight the fact that our unified framework for quadratic loss gives a significant improvement over logistic loss in terms of runtime performance. We also observe that the piecewise quadratic bounding technique has better predictive performance than the quadratic approximation, along with a huge speedup when we compare it to the time to train the model using the logistic loss. FIG. 6A shows a plot of the test RMSE with respect to the iteration number. FIG. 6B shows a plot of the test RMSE with respect to the CPU time. Note: the results shown in FIGS. 6A and 6B are based on simulation data with 10000×5000, sparsity 0.1%, and noise σ=0.1. Markers are plotted at iterations 10, 17, 28, 35, 52, 63, and 73, which times correspond to the refinement of the piecewise bound.

It is interesting to see that the piecewise quadratic bound reaches its goal of interpolating the performances between the fast but inaccurate quadratic approximation, and the slow but accurate logistic loss minimization: On a wide range of times (from 2 minutes to 1 hour), the piecewise quadratic bound gives the best performances. It is worth noting that the slight modification that was introduced to perform exact logistic on the smallest pieces improves performances when the methods have nearly converged (after 60 iterations). Note that this experiment was conducted on matrices, but the differences are even bigger for tensors of high order.

Real Data Experiments

In order to evaluate the performances of the methods herein, link-prediction experiments were designed on standard multi-relational datasets: Nations (with 14 entities and 56 relation types), Kinships (with 104 entities and 26 relation types), and UMLS (with 135 entities and 49 relation types). These datasets results in tensors Yε{0, 1}^{14×14×56}, Yε{0, 1}^{104×104×26}, and Yε{0, 1}^{135×135×29}, respectively. Then, the Area Under the Receiver Operating Characteristic Curve (AUC) and runtime in seconds were compared to the results of RESCAL, SME, and LFM that have the best published results on these benchmarks in terms of AUC.

In addition, the performances of these methods were tested on three datasets in matrix form: MovieLens, Last FM, and Sushi Preference. MovieLens dataset contains movie ratings of approximately 1682 movies made by 943 MovieLens users and results in matrix Yε{0, 1}^{943×1682}. The Last FM dataset consists of music artist listening information from a set of 1892 users from Last.fm online music system. A binary matrix Yε{0, 1}^{1892×17632} was constructed from this dataset that contains the artists listened to by each user. Lastly, the Sushi Preference Data Set includes 4950 users' responses of preference in 100 different kinds of sushi. In this dataset, the most disliked kind of sushi represented by 0 and the most preferred one is represented by 1. Eventually, sushi dataset results in matrix Yε{0, 1}^{100×4950}.

Table 3 shows the results of applying the methods described herein to the three data sets.

TABLE 3

| | | Datasets | | | | | |
|---|---|---|---|---|---|---|---|
| | Methods | Nations | Kinships | UMLS | MovieLens | Last FM | Sushi |
| AUC | EUC-FULL | 0.7536 | 0.8193 | 0.8205 | 0.8511 | 0.8965 | 0.8199 |
| | EUC-Fast | 0.7536 | 0.8193 | 0.8205 | 0.8511 | 0.8965 | 0.8199 |
| | Logistic | 0.9253 | 0.9592 | 0.9795 | 0.9848 | 0.9454 | 0.9513 |
| | Quad-App | 0.8635 | 0.9087 | 0.9169 | 0.8916 | 0.9042 | 0.9078 |
| | PW QuadApp | 0.9038 | 0.9213 | 0.9387 | 0.9490 | 0.9272 | 0.9200 |
| | PW Quad + Logistic | 0.9122 | 0.9416 | 0.9566 | 0.9781 | 0.9381 | 0.9373 |
| | RESCAL (Nickel et al., 2011) | 0.8400 | 0.9500 | 0.9800 | 0.9601 | 0.9257 | 0.9481 |
| | SME (Bordes et al., 2013) | 0.8830 | 0.9070 | 0.9830 | 0.9144 | 0.9328 | 0.9177 |
| | LFM (Jenatton et al., 2012) | 0.9090 | 0.9460 | 0.9900 | 0.9790 | 0.9401 | 0.9598 |
| Time | EUC-Full | 922.87 | 8793.8 | 81039 | 103454 | 701819 | 13490.8 |
| (sec) | EUC-Fast | 18.37 | 80.95 | 167.67 | 344.81 | 3688.74 | 142.63 |
| | Logistic | 1483.7 | 10374.2 | 75489 | 111257 | 721994 | 12704.6 |
| | Quad-App | 18.07 | 97.13 | 187.1 | 431.35 | 1839.16 | 142.06 |
| | PieceQuadApp | 32.52 | 169.35 | 922.65 | 1095.94 | 2792.18 | 643.56 |
| | PW Quad + Logistic | 59.71 | 651.12 | 1035.47 | 1349.6 | 4065.12 | 755.72 |
| | RESCAL (Nickel et al., 2011) | 626.40 | 3714.6 | 4142.05 | 6786.23 | 9861.50 | 2632.1 |
| | SME (Bordes et al., 2013) | 32.11 | 135.9 | 513.03 | 749.07 | 1627.56 | 279.38 |
| | LFM (Jenatton et al., 2012) | 64.63 | 1446.22 | 5097.5 | 8265.56 | 13058.1 | 3438.07 |

For the results given in Table 3, 10-fold cross validation was performed and averaged over 10 random splits of the datasets. In addition, an optimal regularization parameter λ* was selected by searching over the set {0.01, 0.05, 0.1, 0.5, 1} that maximizes the AUC. The rank-20 decomposition of these datasets was computed in order to get comparable results to RESCAL, SME, and LFM. The time and accuracy comparisons are given in Table 3 in terms of seconds for time and AUC metric for predicting missing values. These results demonstrate that logistic loss improves accuracy over RESCAL, SME, and LFM in Nations, Kinships, MovieLens, and Last FM datasets while it reaches almost the same score for UMLS and Sushi datasets. On the other side, piecewise methods provide very close approximation to logistic loss on all these datasets and they have a significant advantage in terms of runtime over the other methods. They take a small fraction of running time for the logistic losses, especially for large datasets.

The techniques described herein include:
1) decomposition of the loss into a small positive part and a large but structured negative space;
2) bounding the quadratic loss to reduce the complexity of squared loss computation; and
3) use of the partitioning technique to gradually reduce the gap introduced by the usage of quadratic upper bounds for non-quadratic losses.

It has been found that the techniques are particularly useful in the case of binary or count data. This combination of techniques can be applied in a broad range of other problems, such as probabilistic CCA, collective matrix factorization, non-negative matrix factorization, as well as non-factorial models such as time series.

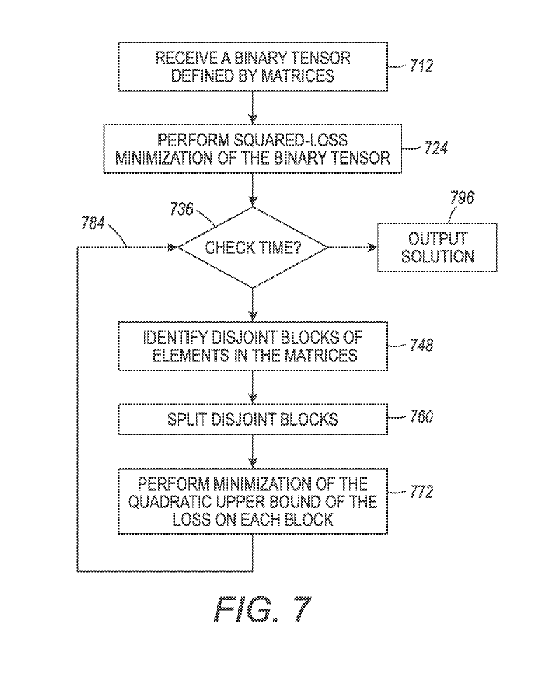

FIG. 7 is a flow diagram illustrating the processing flow of an exemplary method according to systems and methods herein. At 712, a processing device receives a binary tensor defined by matrices comprising elements in a database. At 724, the processing device performs squared-loss minimization of the binary tensor. At 736, the amount of time allocated for the computation is checked. If time is available, factorization continues by identifying disjoint blocks of elements in the matrices, as indicated at 748. At 760, ones of the disjoint blocks having maximal variance in the absolute values of a predicted value of the elements in the blocks are split. At 772, minimization of the quadratic upper bound of the loss on each block is performed. An upper bound for losses associated with the factorization may be determined by alternately minimizing the upper bound with respect to a variation parameter and minimizing the upper bound with respect to the elements in the matrices using a gradient descent function. This process is repeated, as indicated by line 784 until the total amount of time allocated for the computation has been reached. Once this time has been reached, a solution is output, as shown at 796. One can check the accuracy of the solution, for example, by evaluating the prediction accuracy of the estimated parameters on unseen test data.

Aspects of the present disclosure are described herein with reference to flowchart illustrations and/or block diagrams of methods, apparatus (systems), and computer program products according to various systems and methods. It will be understood that each block of the flowchart illustrations and/or two-dimensional block diagrams, and combinations of blocks in the flowchart illustrations and/or block diagrams, can be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

According to a further system and method herein, an article of manufacture is provided that includes a tangible computer readable medium having computer readable instructions embodied therein for performing the steps of the computer implemented methods, including, but not limited to, the method illustrated in FIG. 7. Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination of the foregoing. Any of these devices may have computer readable instructions for carrying out the steps of the methods described above with reference to FIG. 7.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Furthermore, the computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

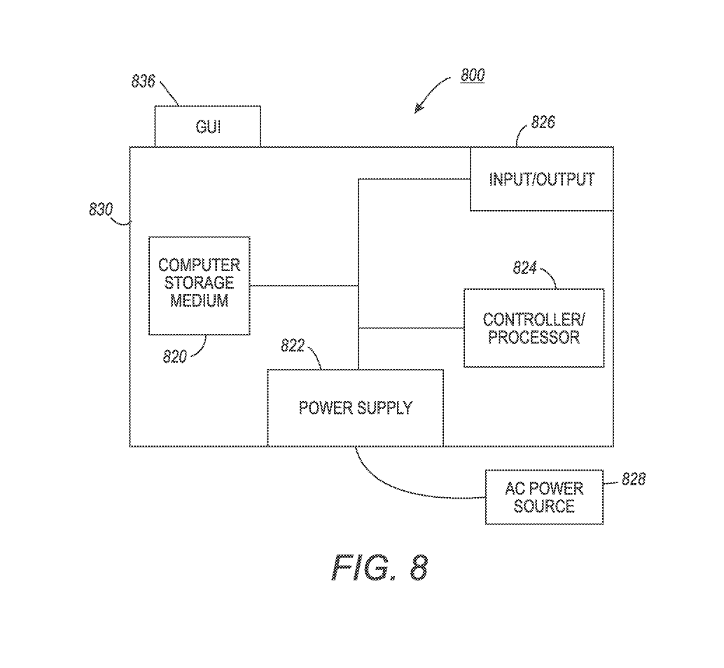

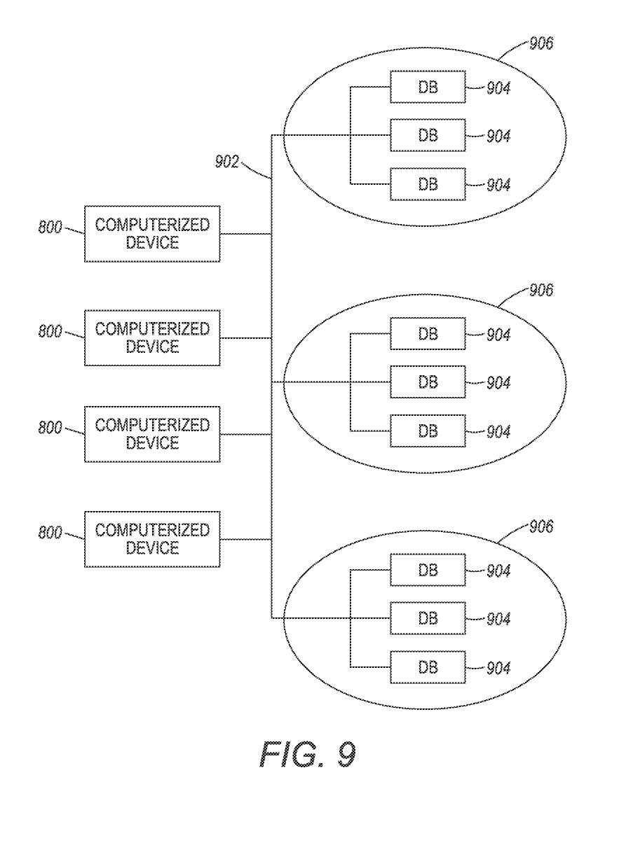

FIG. 8 illustrates a computerized device 800, which can be used with systems and methods herein and can comprise, for example, a personal computer, a portable computing device, etc. The computerized device 800 includes a controller/processor 824 and a communications port (input/output) 826 operatively connected to the controller/processor 824. As described above, the controller/processor 824 may also be connected and to a computerized network 902 external to the computerized device 800, such as shown in FIG. 9. In addition, the computerized device 800 can include at least one accessory functional component, such as a graphic user interface assembly (GUI) 836 that also operates on the power supplied from the external power source 828 (through the power supply 822).

The input/output device 826 is used for communications to and from the computerized device 300. The controller/processor 824 controls the various actions of the computerized device. A non-transitory computer storage medium 820 (which can be optical, magnetic, capacitor based, etc.) is readable by the controller/processor 824 and stores instructions that the controller/processor 824 executes to allow the computerized device 800 to perform its various functions, such as those described herein. Thus, as shown in FIG. 8, a body housing 830 has one or more functional components that operate on power supplied from the alternating current (AC) power source 828 to the power supply 822. The power supply 822 can comprise a power storage element (e.g., a battery) and connects to an external alternating current power source 828 and converts the external power into the type of power needed by the various components.

In case of implementing the systems and methods herein by software and/or firmware, a program constituting the software may be installed into a computer with dedicated hardware, from a storage medium or a network, and the computer is capable of performing various functions if with various programs installed therein.

In the case where the above-described series of processing is implemented with software, the program that constitutes the software may be installed from a network such as the Internet or a storage medium such as the removable medium.

Those skilled in the art would appreciate that the storage medium is not limited to a peripheral device having the program stored therein, which is distributed separately from the device for providing the program to the user. Examples of a removable medium include a magnetic disk (including a floppy disk), an optical disk (including a Compact Disk-Read Only Memory (CD-ROM) and a Digital Versatile Disk (DVD)), a magneto-optical disk (including a Mini-Disk (MD) (registered trademark)), and a semiconductor memory. Alternatively, the computer storage medium 820 may be a hard disk, or the like, which has the program stored therein and is distributed to the user together with the device that contains them.

As will be appreciated by one skilled in the art, aspects of the devices and methods herein may be embodied as a system, method, or computer program product. Accordingly, aspects of the present disclosure may take the form of an entirely hardware system, an entirely software system (including firmware, resident software, micro-code, etc.) or an system combining software and hardware aspects that may all generally be referred to herein as a “circuit,” “module”, or “system.” Furthermore, aspects of the present disclosure may take the form of a computer program product embodied in one or more computer readable medium(s) having computer readable program code embodied thereon.

Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a Read Only Memory (ROM), an Erasable Programmable Read Only Memory (EPROM or Flash memory), an optical fiber, a magnetic storage device, a portable compact disc Read Only Memory (CD-ROM), an optical storage device, a “plug-and-play” memory device, like a USB flash drive, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods, and computer program products according to various devices and methods herein. In this regard, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As shown in FIG. 9, exemplary systems and methods herein may include various computerized devices 800 and databases 904 located at various different physical locations 906. The computerized devices 800 and databases 904 are in communication (operatively connected to one another) by way of a local or wide area (wired or wireless) network 902.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the systems and methods described herein. Similarly, scanners and other similar peripheral equipment are available from Xerox Corporation, Norwalk, Conn., USA and the details of such devices are not discussed herein for purposes of brevity and reader focus.

The terminology used herein is for the purpose of describing particular devices and methods only and is not intended to be limiting of this disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, the terms ‘automated’ or ‘automatically’ mean that once a process is started (by a machine or a user), one or more machines perform the process without further input from any user.

The corresponding structures, materials, acts, and equivalents of all means or step plus function elements in the claims below are intended to include any structure, material, or act for performing the function in combination with other claimed elements as specifically claimed. The descriptions of the various devices and methods of the present disclosure have been presented for purposes of illustration, but are not intended to be exhaustive or limited to the devices and methods disclosed. Many modifications and variations will be apparent to those of ordinary skill in the art without departing from the scope and spirit of the described devices and methods. The terminology used herein was chosen to best explain the principles of the devices and methods, the practical application or technical improvement over technologies found in the marketplace, or to enable others of ordinary skill in the art to understand the devices and methods disclosed herein.

It will be appreciated that the above-disclosed and other features and functions, or alternatives thereof, may be desirably combined into many other different systems or applications. Those skilled in the art may subsequently make various presently unforeseen or unanticipated alternatives, modifications, variations, or improvements therein, which are also intended to be encompassed by the following claims. Unless specifically defined in a specific claim itself, steps or components of the systems and methods herein should not be implied or imported from any above example as limitations to any particular order, number, position, size, shape, angle, color, temperature, or material.

What is claimed is:

1. A method comprising:
receiving, by a processing device, a tensor defined by matrices comprising elements in a database; and
performing, by said processing device, factorization of said tensor, said factorization comprising:
identifying disjoint blocks of elements in said tensor;
splitting ones of said disjoint blocks having maximal variance in the absolute values of a predicted value of said elements in said blocks;
determining an upper bound on every one of said disjoint blocks of said tensor for losses associated with said factorization; and
minimizing said upper bound with respect to a variation parameter and elements in said factorization using a gradient descent function.

2. The method according to claim 1, said matrices comprising unbalanced datasets having more negative entries than positive entries.

3. The method according to claim 1, said upper bound being minimized to non-quadratic losses.

4. The method according to claim 1, said upper bound for losses being applied individually for each block of elements and said minimizing being applied jointly on all blocks.

5. The method according to claim 1, said tensor comprising missing information, said method further comprising:
predicting values for said missing information, said values being consistent with existing elements in said matrices based on said factorization.

6. A method, comprising:
receiving, by a processing device, a binary tensor defined by matrices comprising elements in a database;
determining, by said processing device, an upper bound for non-quadratic losses associated with factorization of said binary tensor, said upper bound being based on a variation parameter; and
performing, by said processing device, factorization of said binary tensor by minimizing said upper bound with respect to said variation parameter and said elements of said matrices using a gradient descent function.

7. The method according to claim 6, said matrices comprising unbalanced datasets having more negative entries than positive entries.

8. The method according to claim 6, said factorization of said binary tensor, said factorization comprising:
identifying disjoint blocks of elements in said matrices,
splitting ones of said disjoint blocks having maximal variance in the absolute values of a predicted value of said elements in said blocks, and
determining said upper bound for losses associated with said factorization by minimizing said upper bound with respect to a variation parameter and said elements in said matrices using a gradient descent function.

9. The method according to claim 8, said upper bound for losses being applied individually for each block of elements and said minimizing being applied jointly on all blocks.

10. The method according to claim 6, said binary tensor comprising missing information, said method further comprising:
predicting values for said missing information, said values being consistent with existing elements in said matrices based on said factorization.

11. A computer program product for conducting factorization of tensors, said computer program product comprising a computer readable storage medium having program instructions embodied therewith, the program instructions being readable/executable by a processor, to cause said processor to perform a method comprising:
receiving a tensor defined by matrices comprising elements in a database;
classifying said elements in said database by:
identifying blocks of elements in said matrices;
splitting ones of said blocks having maximal variance in the absolute values of a predicted value of said elements in said blocks; and
performing factorization of said tensor according to said blocks of elements, said factorization comprising determining an upper bound for losses associated with said factorization by minimizing said upper bound with respect to a variation parameter and said elements in said matrices using a gradient descent function.

12. The computer program product according to claim 11, said matrices comprising unbalanced datasets having more negative entries than positive entries.

13. The computer program product according to claim 11, said method further comprising minimizing said upper bound to non-quadratic losses.

14. The computer program product according to claim 11, said method further comprising said upper bound for losses being applied individually for each block of elements and said minimizing being applied jointly on all blocks.

15. The computer program product according to claim 11, said tensor comprising missing information, said method further comprising:
predicting values for said missing information, said values being consistent with existing elements in said matrices based on said factorization.

16. A computer system for conducting binary tensor factorization, comprising:
a knowledge database being defined as a binary tensor;
a processing device connected to said knowledge database; and
a program product comprising a computer readable storage medium having program code embodied therewith, said program code being readable and executable by said processing device to perform a method comprising:
factorizing said binary tensor, said factorizing comprising interpolating between a fast, imprecise solution to said factorizing and a slow, precise solution to said factorizing, based on minimizing a quadratic upper bound to said precise solution using piece-wise blocks of elements in said binary tensor.

17. The computer system according to claim 16, said binary tensor being defined by matrices comprising elements in said knowledge database, said matrices comprising unbalanced datasets having more negative entries than positive entries.

18. The computer system according to claim 17, factorizing said binary tensor comprising:
identifying disjoint blocks of said elements in said matrices,
splitting ones of said disjoint blocks having maximal variance in the absolute values of a predicted value of said elements in said blocks, and
determining said upper bound for losses associated with said factorizing by minimizing said upper bound with respect to a variation parameter and said elements in said matrices using a gradient descent function.

19. The computer system according to claim 18, said upper bound for losses being applied individually for each block of elements and said minimizing being applied jointly on all blocks.

20. The computer system according to claim 17, said binary tensor comprising missing information, said method further comprising:
predicting values for said missing information, said values being consistent with existing elements in said matrices based on said factorizing.
